(19) United States
(12) Patent Application Publication
(10) Pub. No.: US 2025/0370080 A1
(43) Pub. Date: Dec. 4, 2025

(54) POSITIONING PROCEDURE BASED ON ELECTRONIC SHELF LABEL (ESL) NETWORK

(71) Applicant: QUALCOMM Incorporated, San Diego, CA (US)

(72) Inventor: Laksh BHATIA, London (GB)

(21) Appl. No.: 18/732,259

(22) Filed: Jun. 3, 2024

(51) Int. Cl. G01S 1/04

(52) U.S. Cl. CPC G01S 1/0428; G01S 1/047

(57) ABSTRACT

In an aspect, a method of operating a processing device includes obtaining location information of a target device, transmission time information of first one or more beacons transmitted by the target device, or transmission channel information of the first one or more beacons; and configuring a first set of electronic shelf label (ESL) devices to perform a targeted scanning operation based on the location information, the transmission time information, or the transmission channel information. The method of operating the processing device further includes receiving one or more targeted scanning reports from the first set of ESL devices based on the targeted scanning operation, and engaging in a positioning procedure for determining an estimated location of the target device based on the one or more targeted scanning reports.

### BACKGROUND OF THE DISCLOSURE

### 1. Field of the Disclosure

Aspects of the disclosure relate generally to wireless technologies.

### 2. Description of the Related Art

Electronic shelf label (ESL) devices are used by retailers for displaying product pricing or other product information to consumers. ESL devices typically use electronic paper (e-paper) or liquid crystal display (LCD) to display the current information. E-paper (also referred to as e-ink) is widely used for ESL devices, as it provides a sharp display and supports full graphic imaging while only needing power during updates and no power to retain an image.

ESL devices are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a processing device includes obtaining location information of a target device, transmission time information of first one or more beacons transmitted by the target device, transmission channel information of the first one or more beacons, or a combination thereof; configuring a first set of electronic shelf label (ESL) devices to perform a targeted scanning operation arranged for scanning the first one or more beacons from a target scanning zone based on the location information, the transmission time information, the transmission channel information, or a combination thereof; receiving one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and engaging in a positioning procedure for determining an estimated location of the target device based on the one or more targeted scanning reports.

In an aspect, a processing device includes one or more memories; one or more transceivers; and one or more processors communicatively coupled to the one or more memories and the one or more transceivers, the one or more processors, either alone or in combination, configured to: obtain location information of a target device, transmission time information of first one or more beacons transmitted by the target device, transmission channel information of the first one or more beacons, or a combination thereof; configure a first set of electronic shelf label (ESL) devices to perform a targeted scanning operation arranged for scanning the first one or more beacons from a target scanning zone based on the location information, the transmission time information, the transmission channel information, or a combination thereof; receive, via the one or more transceivers, one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and engage in a positioning procedure for determining an estimated location of the target device based on the one or more targeted scanning reports.

In an aspect, a processing device includes means for obtaining location information of a target device, transmission time information of first one or more beacons transmitted by the target device, transmission channel information of the first one or more beacons, or a combination thereof; means for configuring a first set of electronic shelf label (ESL) devices to perform a targeted scanning operation arranged for scanning the first one or more beacons from a target scanning zone based on the location information, the transmission time information, the transmission channel information, or a combination thereof; means for receiving one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and means for engaging in a positioning procedure for determining an estimated location of the target device based on the one or more targeted scanning reports.

In an aspect, a non-transitory computer-readable medium stores computer-executable instructions that, when executed by a processing device, cause the processing device to: obtain location information of a target device, transmission time information of first one or more beacons transmitted by the target device, transmission channel information of the first one or more beacons, or a combination thereof; configure a first set of electronic shelf label (ESL) devices to perform a targeted scanning operation arranged for scanning the first one or more beacons from a target scanning zone based on the location information, the transmission time information, the transmission channel information, or a combination thereof; receive one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and engage in a positioning procedure for determining an estimated location of the target device based on the one or more targeted scanning reports.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic shelf label (ESL) network, according to aspects of the disclosure.

FIG. 2 illustrates a simplified functional block diagram of an example ESL device, according to aspects of the disclosure.

FIG. 3 illustrates a simplified functional block diagram of an example processing device that may correspond to a service entity, or a management entity configured to perform various functions of a service entity, according to aspects of the disclosure.

FIG. 4 is a diagram illustrating an example ESL deployment configured to perform a positioning procedure to determine a location of a target device, according to aspects of the disclosure.

FIG. 5 illustrates a first example processing flow for performing a positioning procedure based on an ESL network, according to aspects of the disclosure.

FIG. 6 illustrates a second example processing flow for performing a positioning procedure based on an ESL network, according to aspects of the disclosure.

FIG. 7 illustrates an example processing flow for camping a target device to an ESL network, according to aspects of the disclosure.

FIG. 8 is a flowchart illustrating a method of operating an initiator device, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to a positioning procedure based on an electronic shelf label (ESL) network. Some aspects more specifically relate to configuring ESL devices of the ESL network to scan beacons from a target device.

Particular aspects of the subject matter described in this disclosure can be implemented to realize one or more of the following potential advantages. In some examples, by configuring a targeted scanning operation based on location information of the target device, transmission time information of the beacons, transmission channel information of the beacons, or any combination thereof, only a selected set of the ESL devices and/or a limited scanning time window is needed for scanning the beacons from the target device while ensuring a high probability of successfully receiving the beacons for the positioning procedure. Accordingly, the positioning procedure based on the ESL devices scanning for the beacons from the target device can be performed in a manner that is both timely and power-efficient (as to at least the ESL devices and/or the target device).

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic shelf label (ESL) devices are used by retailers for displaying product pricing or other product information to consumers. ESL devices typically use electronic paper (e-paper or e-ink) or liquid crystal display (LCD) to display the current information.

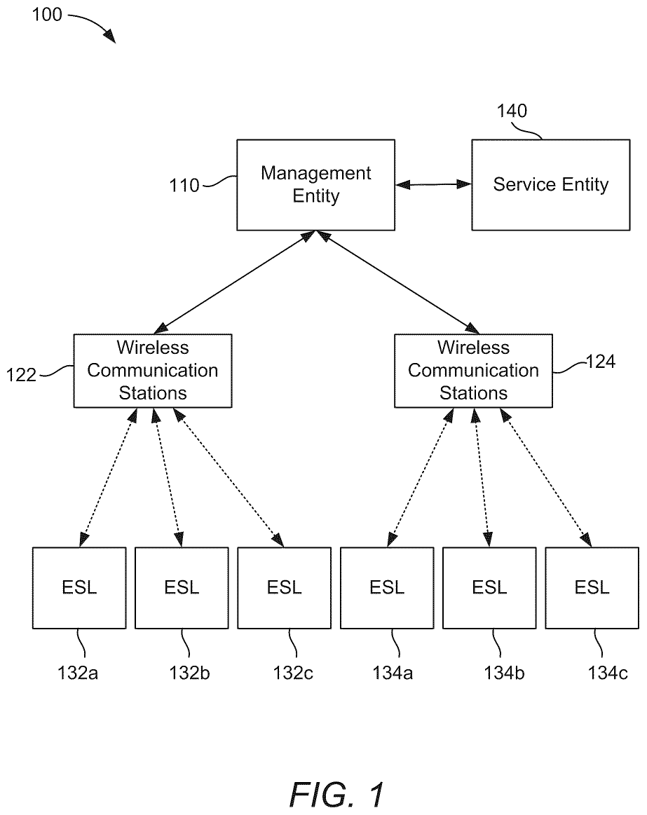

FIG. 1 illustrates an example ESL network 100, according to aspects of the disclosure. As shown in FIG. 1, the ESL network 100 may include a management entity 110 and one or more wireless communication stations (e.g., wireless communication stations 122 and 124). In FIG. 1, one or more ESL devices (e.g., ESL devices 132a, 132b, and 132c) may be configured to receive instructions and/or updates from the wireless communication station 122, and one or more ESL devices (e.g., ESL devices 134a, 134b, and 134c) may be configured to receive instructions and/or updates from the wireless communication station 124. In some aspects, the wireless communication stations 122 and 124 may also be referred to as access points (APs) of the ESL network 100, and may be based on a BLUETOOTH® low energy (BLE) standard, a Wi-Fi standard, or an ambient IoT standard, in some examples. In some aspects, the management entity 110 may be communicatively coupled to the wireless communication stations 122 and 124 through a wired communication network or a wireless communication network.

In some aspects, the management entity 110 may correspond to a local server at the retail location or a cloud-based server that is configured to execute a label management software program for control of the ESL devices 132a-132c and 134a-134c. The label management software may be responsible for the configuration of the ESL network 100, configuration of the properties of the ESL devices 132a-132c and 134a-134c, and storing the database of information to be displayed by the ESL devices 132a-132c and 134a-134c. The software mainly covers the network management, file systems, and transmission of data. The software may also process and pack the data to be displayed into packets of information. The data packets are then sent to one or more wireless communication stations 122 and 124 for distribution to the ESL devices 132a-132c and 134a-134c via a wireless network (e.g., based on a BLE standard, a Wi-Fi standard, or an ambient IoT standard).

A wireless communication station 122 or 124 may be responsible for the stability and reliability of transmissions from the label management software (on the management entity 110) to the ESL devices 132a-132c and 134a-134c. In some aspects, the wireless communication stations 122 and 124 may correspond to two wireless communication stations 122 and 124 (together with the associated ESL devices) deployed in two different retail locations or in a same retail location. In some aspects, there may be multiple wireless communication stations deployed in a single retail location, based on the size of the space and/or the number of ESL devices deployed.

An ESL device (e.g., any of the ESL devices 132a-132c and 134a-134c) may function as a receiver from the wireless communication station it associated with to display the information configured from the label management software. The ESL device then may act based on the instructions that were provided in the data packets (e.g., display the price or product information). An ESL application programming interface (API) is included in the current BLUETOOTH® specification and permits a 7-bit group identifier of 8-bit unique ESL identifiers, allowing for a total of 32,640 ESL devices to be allocated for one wireless communication station. With those constraints, in some examples, multiple wireless communication stations may be needed to cover a typical grocery store ESL application.

Moreover, ESL devices are increasingly being integrated with existing retail technologies, such as electronic article surveillance, digital signage, and people counters. In some aspects, the ESL network 100 may further include a service entity 140 that can work with the management entity 110 in order to render one or more services based on the ESL network 100. For example, the service entity 140 may include a floor plan of the retail store, and may interact with information collected by the ESL devices 132a-132c and 134a-134c and/or the wireless communication stations 122 and 124 to provide a service for tracking one or more target devices. In one example, consumers may be tracked based on the ESL network 100 through positioning a network of people-counting devices carried by the consumers, or via their personal BLUETOOTH® devices, in order to determine their position within the store at all times. This may allow an individual customer to receive targeted, customized marketing initiatives, such as discounts, individual pricing, etc. In some applications, target devices for tracking or positioning may be mounted on store assets (e.g., shopping carts, barcode scanners, product samples, and the like) such that position of the store assets may be ascertained based on the ESL network 100.

In some aspects, the service entity 140 may be an integrated part of the management entity 110. In some aspects, the service entity 140 and the management entity 110 may be implemented as two separate processing devices (e.g., computers) located in one place or located in different places. In some aspects, the service entity 140 may be communicatively coupled to the management entity 110 through a wired communication or a wireless communication.

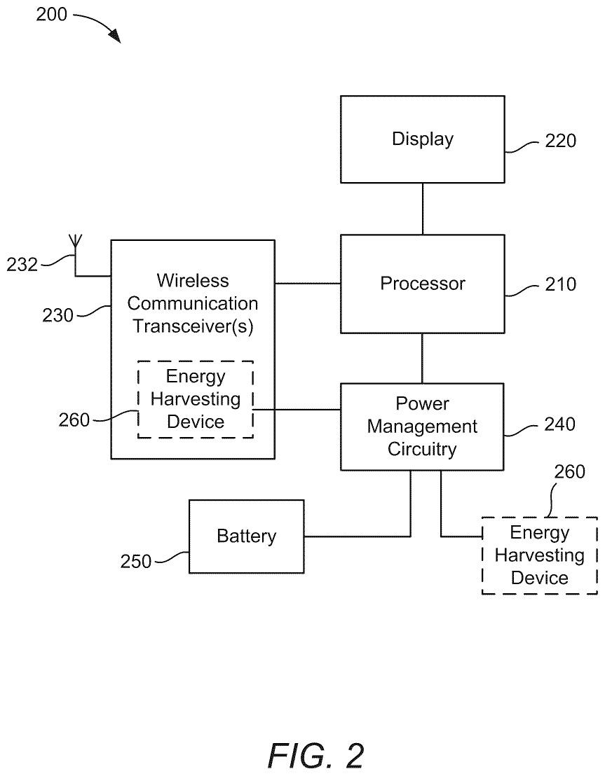

FIG. 2 illustrates a simplified functional block diagram of an example ESL device 200, according to aspects of the disclosure. In some aspects, the ESL device 200 may correspond to any of the ESL devices 132a-132c and 134a-134c in FIG. 1. In some aspects, the example ESL device 200 may be illustrated as a non-limiting example. In some implementations, various components illustrated in FIG. 2 may be modified or omitted. In some implementations, additional components not illustrated in FIG. 2 may be added.

It will be appreciated that the components described in FIG. 2 may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

As shown in FIG. 2, the ESL device 200 may include a processor 210, a display 220 coupled to the processor 210, and one or more wireless communication transceivers 230 coupled to the processor 210. In some aspects, the one or more wireless communication transceivers 230 may include a wireless communication transceiver configured to communicate with the corresponding wireless communication station (e.g., the wireless communication stations 122 and 124) via one or more antennas 232 based on, e.g., a BLE standard, a Wi-Fi standard, or an ambient IoT standard. In some aspects, the ESL device 200 may communicate with a target device to be positioned via the one or more antennas 232 based on the BLE standard, the Wi-Fi standard, or the ambient IoT standard. In some aspects, the display 220 may include an e-paper display or an LCD display configured to display the information the processor 210 received from the wireless communication station via the one or more wireless communication transceivers 230.

In some aspects, the ESL device 200 may further include power management circuitry 240 coupled to the processor 210. The power management circuitry 240 may receive electrical energy from a battery 250 and/or an energy harvesting device 260 (which may be part of the one or more wireless communication transceivers 230 or outside the one or more wireless communication transceivers 230), and provide the electrical energy to the processor 210, the display 220, and the one or more wireless communication transceivers 230.

In some aspects, multiple ESL devices may share a same set of wireless communication transceiver(s) if these ESL devices are disposed in a same area (e.g., the same shelf) where a communication bus (not shown in FIG. 2) can be easily implemented to couple these ESL devices together. In this disclosure, for the purpose of illustrating the positioning procedure for a target device based on an ESL network, the ESL devices sharing a same wireless communication transceiver(s) component would be collectively considered as one ESL device, and the location of the wireless communication transceiver(s) component would be considered as the location of the corresponding ESL device.

In some aspects, the processor 210 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof. In some aspects, the processor 210 may include a memory configured to store data and/or computer-readable instructions to be executed by the processor for performing various operations of the ESL device 200.

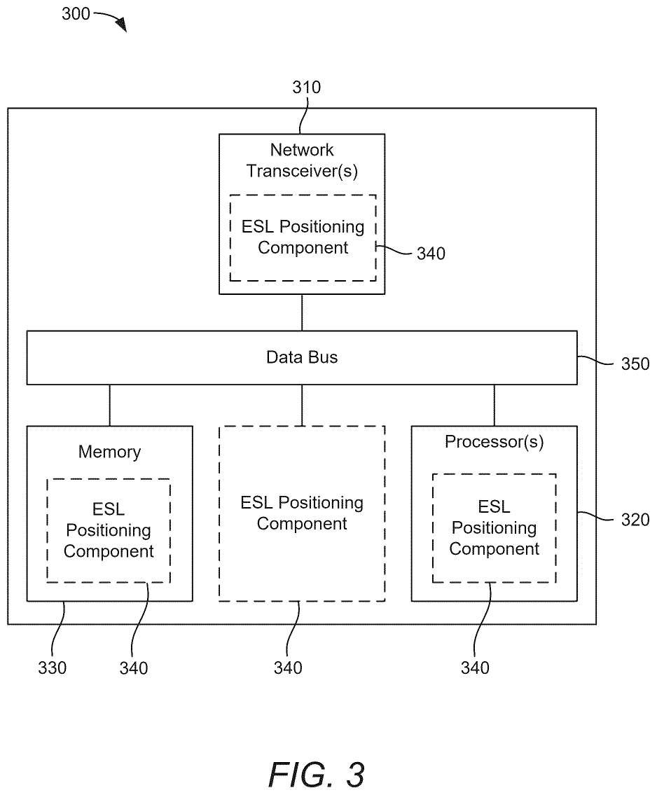

FIG. 3 illustrates a simplified functional block diagram of an example processing device 300 that may correspond to a service entity (e.g., the service entity 140) or a management entity configured to perform the functions of a service entity (e.g., the management entity 110 incorporating the functions of the service entity 140), according to aspects of the disclosure. In some aspects, in a case that the processing device 300 corresponds to the service entity implemented as a separate entity from the management entity, the processing device 300 may correspond to a location management function (LMF) in a communication network, a location server, an over-the-top server, or a proprietary server.

It will be appreciated that the components described in FIG. 3 may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

As shown in FIG. 3, the processing device 300 may include one or more network transceivers 310 providing means for communicating (e.g., means for transmitting, means for receiving, etc.) with other entities or devices (e.g., the management entity 110, the wireless communication stations 122 and 124, and/or other network entities) based on a wired communication or a wireless communication. In some aspects, a transceiver may be configured to communicate over a wired or wireless link. A transceiver (whether a wired transceiver or a wireless transceiver) may include transmitter circuitry and receiver circuitry. A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry may include or be coupled to one or more antennas. Similarly, wireless receiver circuitry may include or be coupled to one or more antennas. In an aspect, the transmitter circuitry and receiver circuitry may share the same one or more antennas, such that the processing device 300 can only receive or transmit at a given time, not both at the same time.

The processing device 300 may also include other components that may be used in conjunction with the operations as disclosed herein. The processing device 300 may include one or more processors 320 for providing functionality relating to, for example, wireless communication, positioning, and/or other processing functionality. The processors 320 may therefore provide means for processing, such as means for determining, means for calculating, means for receiving, means for transmitting, means for indicating, etc. In an aspect, the processors 320 may include, for example, one or more general purpose processors, multi-core processors, CPUs, ASICs, DSPs, FPGAs, other programmable logic devices or processing circuitry, or various combinations thereof.

The processing device 300 may include memory circuitry implementing a memory 330 (e.g., including a memory device) for maintaining information (e.g., information indicative of reserved resources, thresholds, parameters, and so on). The memory 330 may therefore provide means for storing, means for retrieving, means for maintaining, etc. In some cases, the processing device 300 may include ESL positioning component 340. The ESL positioning component 340 may be hardware circuits that are part of or coupled to the processors 320 that may be operated to cause the processing device 300 to perform the functionality described herein. In other aspects, the ESL positioning component 340 may be external to the processors 320 (e.g., a standalone component or integrated with another component). Alternatively, the ESL positioning component 340 may correspond to computer readable instructions stored in the memory 330 that, when executed by the processors 320 (or another processing component or circuitry), cause the processing device 300 to perform the functionality described herein. FIG. 3 illustrates possible locations of the ESL positioning component 340, which may be, for example, part of the one or more network transceivers 310, the memory 330, the one or more processors 320, or any combination thereof, or may be a standalone component.

The various components of the processing device 300 may be communicatively coupled to each other over a data bus 350. In an aspect, the data bus 350 may form, or be part of, a communication interface of the processing device 300. For example, where different logical entities are embodied in the same device, the data bus 350 may provide communication between them. In addition, although not shown, the processing device 300 may include a user interface providing means for providing indications (e.g., audible and/or visual indications) to a user and/or for receiving user input (e.g., upon user actuation of a sensing device such a keypad, a touch screen, a microphone, and so on).

For convenience, the processing device 300 is shown in FIG. 3 as including various components that may be configured according to the various examples described herein. It will be appreciated, however, that the illustrated components may have different functionality in different designs. In particular, various components in FIG. 3 may be optional in alternative configurations and the various aspects include configurations that may vary due to design choice, costs, use of the device, or other considerations. For brevity, illustration of the various alternative configurations is not provided herein, but would be readily understandable to one skilled in the art.

The components of the ESL device 200 in FIG. 2 and/or the components of the processing device 300 in FIG. 3 may be implemented in various ways. In some implementations, the components of the ESL device 200 and/or the processing device 300 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 340 may be implemented by processor and memory component(s) of the processing device 300 (e.g., by execution of appropriate code and/or by appropriate configuration of processor components). For simplicity, various operations, acts, and/or functions are described herein as being performed “by an ESL device,” “by a processing device,” etc. However, as will be appreciated, such operations, acts, and/or functions may actually be performed by specific components or combinations of components of the ESL device 200 or the processing device 300, such as the processors 210, the wireless communication transceivers 230, the processors 320, the network transceivers 310, the memory 330, the ESL positioning component 340, etc.

In some applications, an ESL network may be used in many other operations in addition to updating and showing product information and prices. In some examples, an indoor positioning procedure for determining an indoor position of a user equipment (UE) may be performed based on the UE receiving beacons (e.g., beaconing implemented based on a BLE standard, a, WiFi standard, or an ambient IoT standard) from the ESL devices. There are various techniques available for estimating indoor position based on the beacons' signal strengths (e.g., received signal strength indicators (RSSIs)) as observed by the UE. Detected beacons from nearby BLE devices at known locations can be used to determine an estimate location of the UE.

The present disclosure further describes a target device positioning procedure based on an ESL network, according to various aspects of the disclosure. In some aspects, a target device (such as an ESL device, a tag based on a simplified ESL device, a tag based on a BLE standard, a UE with BLE capability, or a BLE device) may be mounted on an asset (e.g., shopping carts, barcode scanners, product samples for demonstrations, and the like). In some aspects, an ESL network may be used to position and/or track the target device based on the beacons from the target device and received by the ESL devices in the ESL network.

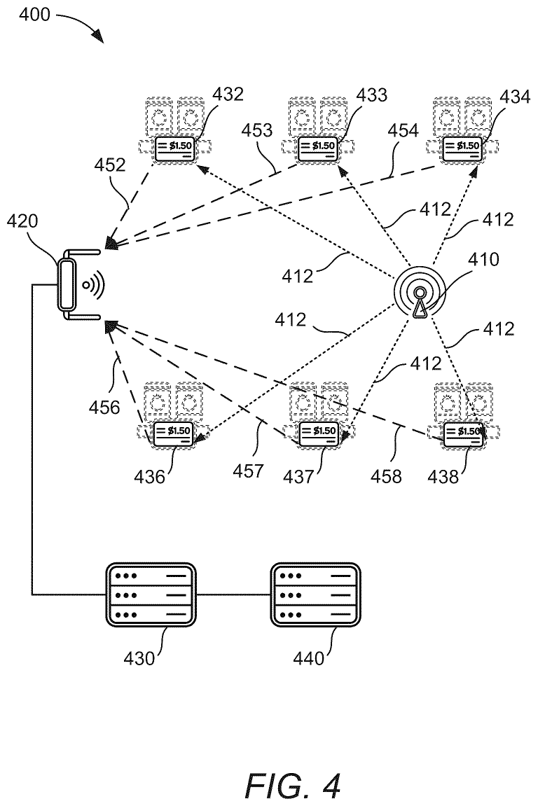

FIG. 4 is a diagram 400 illustrating an example ESL deployment configured to perform a positioning procedure to determine a location of a target device 410, according to aspects of the disclosure. In some aspects, the target device 410 may be mounted on a store asset (e.g., a shopping cart, barcode scanner, product sample, or the like) such that position of the store asset may be ascertained based on the ESL network. In some aspects, the target device 410 may be capable of transmitting beacons (represented by lines 412) that will be received and reported by various ESL devices in the ESL network. In some aspects, the target device 410 may be implemented based on an ESL-capable device (e.g., the ESL device 200 in FIG. 2 or a simplified variation thereof).

As shown in FIG. 4, an ESL network may include a wireless communication station 420 in association with ESL devices 432, 433, 434, 436, 437, and 438. In some aspects, the ESL devices 432, 433, 434, 436, 437, and 438 may correspond to the ESL devices 132a, 132b, and 132c in FIG. 1 and the wireless communication station 420 may correspond to the wireless communication station 122. In some aspects, the ESL devices 432, 433, 434, 436, 437, and 438 may correspond to the ESL devices 134a, 134b, and 134c in FIG. 1 and the wireless communication station 420 may correspond to the wireless communication station 124. In some aspects, the ESL devices 432, 433, 434, 436, 437, and 438 may be implemented based on the ESL device 200 in FIG. 2.

In some aspects, the ESL devices 432, 433, 434, 436, 437, and 438 being associated with the wireless communication station 420 may correspond to the wireless communication station 420 is operated with certain knowledge (in time domain, in frequency domain, and/or based on a communication standard) regarding the ESL devices 432, 433, 434, 436, 437, and 438 such that the wireless communication station 420 may properly transmit instructions, inquiries, and/or updates to the ESL devices 432, 433, 434, 436, 437, and 438. In some aspects, the ESL devices 432, 433, 434, 436, 437, and 438 being associated with the wireless communication station 420 may correspond to the ESL devices 432, 433, 434, 436, 437, and 438 are operated with certain knowledge (in time domain, in frequency domain, and/or based on the communication protocol) regarding the wireless communication station 420 such that the ESL devices 432, 433, 434, 436, 437, and 438 may timely wake up for receiving instructions, inquiries, and/or updates from the wireless communication station 420. In some aspects, such association may correspond to established communication links between the ESL devices and the wireless communication station 420. In some aspects, such association may correspond to a loose relationship based on a connectionless communication standard without establishing a communication link.

As shown in FIG. 4, the ESL network may include a management entity 430 communicatively coupled to the wireless communication station 420. The ESL network may further include a service entity 440 communicatively coupled to the management entity 430 (or alternatively may be incorporated in the management entity 430). In some aspects, the management entity 430 may correspond to the management entity 110 in FIG. 1. In some aspects, the service entity 440 may correspond to the service entity 140 in FIG. 1. In some aspects, the management entity 430, the service entity 440, or both, may be implemented based on the processing device 300 in FIG. 3.

As show in FIG. 4, in order to determine a position of the target device 410, the service entity 440 may coordinate with the management entity 430 to configure the ESL devices 432, 433, 434, 436, 437, and 438 to scan the beacons (represented by lines 412) from the target device 410. The ESL devices 432, 433, 434, 436, 437, and 438 may provide scanning reports (represented by lines 452, 453, 454, 456, 457, and 458) to the service entity 440 through the wireless communication station 420 and the management entity 430. With the known locations of the ESL devices 432, 433, 434, 436, 437, and 438 and the characteristics (e.g., time of arrival, signal strength level, etc.) of the beacons as observed by the ESL devices 432, 433, 434, 436, 437, and 438, the service entity 440 may determine an estimated location of the target device 410 accordingly.

In some aspects, the ESL devices 432, 433, 434, 436, 437, and 438 may be equipped with batteries or energy harvesting devices that are designed to require little or no maintenance for a long period of time (e.g., three to seven years), and thus may impose a limit as to how much energy may be spent on positioning and/or tracking the target device 410. Meanwhile, there may be a practical need to ensure the accuracy and timeliness of the estimated location of the target device 410 (e.g., for stopping store assets being removed from the retail store without permission). Accordingly, there may be a need to position and/or track the target device 410 based on the ESL devices 432, 433, 434, 436, 437, and 438 in an energy-efficient manner while still obtaining the estimated location with desirable accuracy and latency.

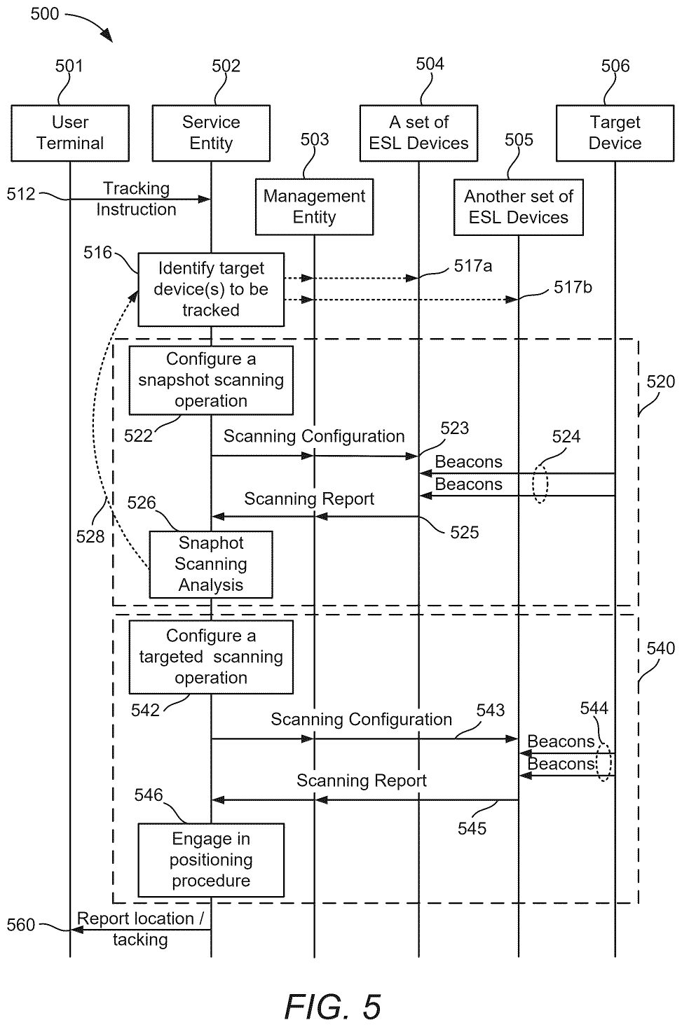

FIG. 5 illustrates a first example processing flow 500 for performing a positioning procedure based on an ESL network, according to aspects of the disclosure. In some aspects, the processing flow 500 indicates the operations performed by a user terminal 501 (e.g., a UE or a handheld computing device), a service entity 502 (e.g., the service entity 440 in FIG. 4), a management entity 503 (e.g., the management entity 430 in FIG. 4), a set of ESL devices 504 (e.g., a subset of the ESL devices 432, 433, 434, 436, 437, and 438), another set of ESL devices 505 (e.g., another subset of the ESL devices 432, 433, 434, 436, 437, and 438), and a target device 506 (e.g., the target device 410 in FIG. 4). In some aspects, an ESL network may be formed based on the service entity 502, the management entity 503, and ESL devices from which the set of ESL devices 504 and set of ESL devices 505 are selected. In some aspects, the service entity 502 and the management entity 503 may be implemented as different hardware devices or as one hardware device.

At stage 512, the user terminal 501 (which may be operated by a user) may send a tracking instruction to the service entity 502. In some aspects, the tracking instruction may indicate the target device 506 to be tracked based on a device identifier of the target device 506. In some aspects, the device identifier may correspond to the BLUETOOTH® device identity address (BD address), the ESL identifier of the target device, a proprietary hardware identifier, or the like, according to one or more communication standards.

At stage 516, the service entity 502 may identify one or more target devices to be tracked, including the target device 506, based on the tracking instruction. In some aspects, the service entity 502 may compile or update a list of device identifiers of the one or more target devices to be tracked (e.g., one or more corresponding BD addresses of the one or more target devices). In some aspects, as indicated by the dotted arrows 517a and 517b, the service entity 502 may send the list, via the management entity 503 and one or more wireless communication stations (not shown in FIG. 5) controllable by the management entity 503, to the set of ESL devices 504, the set of ESL devices 505, or all of the ESL devices reachable by the management entity 503 and made available to the service entity 502 for the positioning procedure. In some aspects, the list may be used by the ESL devices as an allowlist to determine whether certain beacons are to be monitored, decoded, and/or reported, and thus may reduce the power consumption by omitting the beacons that do not carry the device identifiers on the list.

After stage 516, the operations of various entities and devices may enter a snapshot scanning phase 520.

At stage 522 during the snapshot scanning phase 520, the service entity 502 may configure a snapshot scanning operation arranged for scanning one or more beacons from a scanning space by the set of ESL devices 504. In some aspects, the scanning space may be determined based on an area of interest or a last-known location of the target device 506. In some aspects, at stage 522, the set of ESL devices 504 for the snapshot scanning operation may be determined based on an offline setting (e.g., preconfigured based on a floor plan of the store and locations of all the ESL devices installed in the store).

At stage 523, the service entity 502 may configure the set of ESL devices 504 to perform the snapshot scanning operation by sending, via the management entity 503 and one or more corresponding wireless communication stations (not shown in FIG. 5), the scanning configuration from stage 522 to the set of ESL devices 504.

In some aspects, the service entity 502 may configure one or more other sets of ESL devices to perform the snapshot scanning operation for scanning the one or more beacons. In some aspects, set of ESL devices 504 and the one or more other sets of ESL devices may correspond to scanning different scanning zones in the scanning space. In some aspects, each scanning zone may correspond to a different portion of the scanning space. In some aspects, the entire scanning space may correspond to a single scanning zone.

In some aspects, the service entity 502 may create scanning schedules included in the scanning configuration for various sets of ESL devices, where each schedule may specify the device identifier of the target device 506, the ESL identifiers of the ESL devices in each set, and/or the scanning time window (e.g., start, stop, on, off, and/or rate) for each set to scan the beacons. In some aspects, these various sets of ESL devices may be arranged to maximize the coverage of the scanning space.

At stage 524, the set of ESL devices 504 may receive one or more beacons from the target device 508 based on the scanning configuration. In some aspects, the one or more beacons at stage 524 may be transmitted over a dedicated beaconing channel of the ESL network. In some aspects, the target device 506 may periodically transmit beacons based on a beacon transmission time, a beacon transmission interval, or both, regardless of whether any scanning operation has been configured. In some aspects, the target device 506 may transmit beacons upon a request from the service entity 502. In some aspects, for an ESL device of the set of ESL device 504, if a received beacon includes a device identifier matching a device identifier included in the scanning configuration from stage 523, the ESL device may log a number of times the beacons with such device identifier have been received and/or the corresponding reception timestamps thereof. In some aspects, if the number of times the beacon having such device identifier is greater than a threshold number, the ESL device may include such information in a scanning report to the managing entity 503 and/or the service entity 502. In some aspects, the set of ESL device 504 may still scan and include in a report the beacons from devices not included in the list from stage 523.

At stage 525, the service entity 502 may receive one or more snapshot scanning reports from the set of ESL devices 504 based on the snapshot scanning operation. In some aspects, each one of the one or more snapshot scanning reports may indicate an ESL identifier associated with a reporting ESL device of the set of ESL devices 504, a device identifier associated with the target device 506, a number of one or more received bacons received by the reporting ESL device, one or more reception timestamps of the one or more received bacons received by the reporting ESL device, one or more reception signal strengths of the one or more received bacons received by the reporting ESL device, or any combination thereof. In some aspects, the device identifiers and/or the ESL identifiers may be reported in the form of indices or coded indices where the service entity 502 may decode the identifiers based on a lookup table. In some aspects, the one or more snapshot scanning reports may be transmitted based on a large data transfer scheme in a slot according to a BLE standard.

At stage 526, the service entity 502 may perform a snapshot scanning analysis to process the data included in the one or more snapshot scanning reports from stage 525. In some aspects, the service entity 502 may determine location information of the target device 506 (e.g., indicating a coarse location or an area where the target device 506 may locate), transmission time information of one or more beacons to be transmitted by the target device 506 (e.g., indicating when the beacons will be transmitted), transmission channel information of the one or more beacons to be transmitted by the target device 506 (e.g., indicating over which channel(s) the beacons will be transmitted), or a combination thereof.

In some aspects, the service entity 502 may identify a new target device from the one or more snapshot scanning reports, and the processing flow may return to stage 516 (e.g., indicated by a dotted arrow 528) to update the identified target devices to be tracked.

After stage 526, the operations of various entities and devices may enter a targeted scanning phase 540.

At stage 542 during the targeted scanning phase 540, the service entity 502 may configure a targeted scanning operation arranged for scanning another one or more beacons from the target device 506 by the set of ESL devices 505. At stage 543, the service entity 502 may configure the set of ESL devices 505 to perform the targeted scanning operation by sending, via the management entity 503 and corresponding one or more wireless communication stations (not shown in FIG. 5), the scanning configuration from stage 542 to the set of ESL devices 505.

In some aspects, the targeted scanning operation may be based on the location information, the transmission time information, the transmission channel information, or a combination thereof from stage 526. In some aspects, the set of ESL devices 505 may correspond to scanning a target scanning zone in the scanning space, and the target scanning zone may be determined based on the one or more snapshot scanning reports from the snapshot scanning phase 520. In some aspects, the service entity 502 may create a scanning schedule for the set of ESL devices 505, including the device identifier of the target device 506 and/or a scanning time window based on the transmission time information. In some aspects, the transmission time information may indicate that the one or more beacons for the targeted scanning phase 540 will be transmitted periodically based on a beacon transmission time, a beacon transmission interval, or any combination thereof. In some aspects, the transmission channel information may indicate that the one or more beacons for the targeted scanning phase 540 will be transmitted at one or more channels, such as a dedicated beaconing channel of the ESL network.

At stage 544, the set of ESL devices 505 may receive one or more beacons from the target device 506 based on the scanning configuration. In some aspects, the target device 506 may periodically transmit beacons based on the same beacon transmission time and/or beacon transmission interval as those in stage 524, regardless of any scanning operation being configured. In some aspects, the one or more beacons at stage 544 may be transmitted over the dedicated beaconing channel of the ESL network. In some aspects, the target device 506 may transmit beacons upon a request of the service entity 502 or based on a transmission configuration from the service entity 502 and/or the management entity 503. In some aspects, the set of ESL devices 505 may collect information for report from the beacons in a manner similar to the operations at stage 524. In some aspects, the set of ESL devices 505 may collect all information about all beacons (including those from the target device 506, other target devices in the allowlist, and/or other target devices not in the allowlist) received during the configured scanning time window (e.g., all reception timestamps, corresponding device identifiers, and/or reception signal strengths of all received beacons) for report.

At stage 545, the service entity 502 may receive one or more targeted scanning reports from the set of ESL devices 505 based on the targeted scanning operation. In some aspects, each one of the one or more targeted scanning reports may indicate an ESL identifier associated with a reporting ESL device of the set of ESL devices 505, a device identifier associated with the target device 506, a number of one or more received bacons received by the reporting ESL device, one or more reception timestamps of the one or more received bacons received by the reporting ESL device, one or more reception signal strengths of the one or more received bacons received by the reporting ESL device, or any combination thereof. In some aspects, the one or more targeted scanning reports may provide similar data for all received beacons from the target device 506, other target devices in the list from the stage 516, as well as other target devices no in the list. In some aspects, the device identifiers and/or the ESL identifiers may be reported in the form of indices or coded indices where the service entity may decode the identifiers based on a lookup table. In some aspects, the one or more targeted scanning reports may be transmitted based on a large data transfer scheme in a slot according to a BLE standard.

At stage 546, the service entity 502 may engage in a positioning procedure to determine an estimated location of the target device 506 based on the one or more targeted scanning reports. In some aspects, the positioning procedure may correspond to a push-to-fix procedure based on a signature of reception signal strength of the beacons as observed by the set of ESL devices 505.

After the targeted scanning phase 540, at stage 560, the service entity 502 may report the estimated location of the target device 506 to the user terminal 501 and/or or report a tracking result based on the estimated location of the target device 506 to the user terminal 501.

In some aspects, during the snapshot scanning phase 520, the service entity 502 may not have a good understanding of where the target device 506 may be, the transmission timing of the beacons from the target device 506, and/or the transmission channel of the beacons from the target device 506. Therefore, the service entity 502 may select the set of ESL devices 504 that can be sparsely spread around the scanning space with a lower scanning frequency in order to obtain the location information (e.g., a coarse location or a region) of the target device 506, the transmission time information of the beacons transmitted by the target device 506, the transmission channel information of the beacons transmitted by the target device 506, or any combination thereof.

In some aspects, with the information derived from the snapshot scanning phase 520, the service entity 502 during the targeted scanning phase 540 may increase the number of ESL devices for scanning a certain area based on the location information of the target device 506. In some aspects, with the information derived from the snapshot scanning phase 520, the service entity 502 during the targeted scanning phase 540 may identify the channel (e.g., a dedicated beaconing channel of the ESL network) and the timing of the one or more beacons for the targeted scanning phase 540, and may increase the scanning frequency of certain ESL devices with appropriate scanning time and/or scanning durations in order to increase the probability of successfully receiving the beacons from the target device 506.

Accordingly, during the snapshot scanning phase 520, a set of the ESL devices 504 may be configured to scan the beacons of the target device 506 based on a lower power consumption setting. During the targeted scanning phase 540, based on the information derived from the snapshot scanning phase 520, another set of the ESL devices 505 may be configured to scan the beacons of the target device 506 based on a higher power consumption setting but within a limited scanning time and/or scanning duration. As a result, a positioning procedure based on the processing flow 500 may be able to ascertain a location of a target device in a manner that is both timely and power-efficient (as to at least the ESL devices).

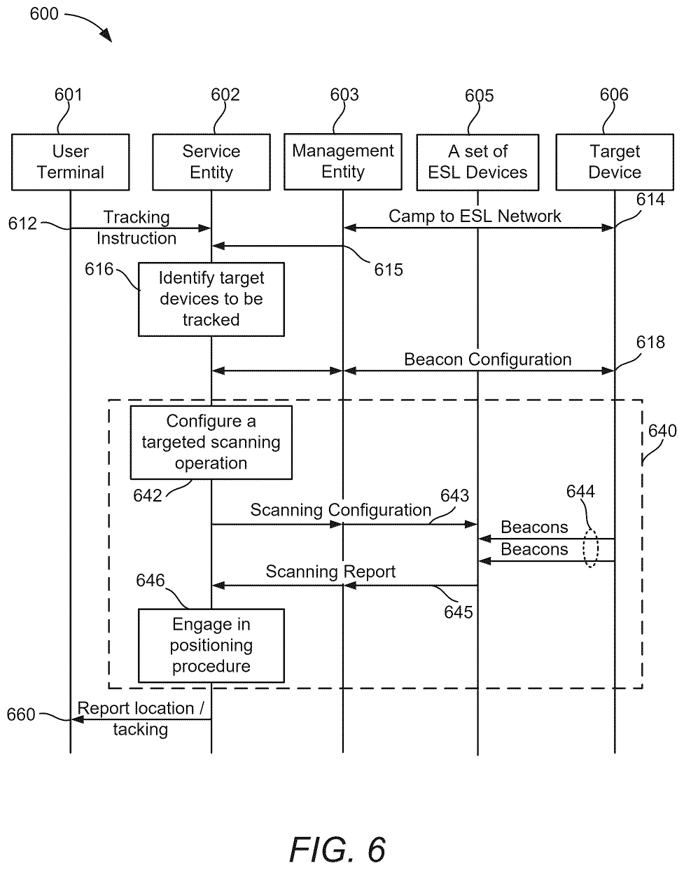

FIG. 6 illustrates a second example processing flow 600 for performing a positioning procedure based on an ESL network, according to aspects of the disclosure. In some aspects, the processing flow 600 indicates the operations performed by a user terminal 601 (e.g., a UE or a handheld computing device), a service entity 602 (e.g., the service entity 440 in FIG. 4), a management entity 603 (e.g., the management entity 430 in FIG. 4), a set of ESL devices 605 (e.g., all or a subset of the ESL devices 432, 433, 434, 436, 437, and 438), and a target device 606 (e.g., the target device 410 in FIG. 4). In some aspects, an ESL network may be formed based on the service entity 602, the management entity 603, and ESL devices from which thee set of ESL devices 605 are selected. In some aspects, the service entity 602 and the management entity 603 may be implemented as different hardware devices or as one hardware device.

At stage 612, the user terminal 601 (which may be operated by a user) may send a tracking instruction to the service entity 602. In some aspects, the tracking instruction may indicate the target device 606 to be tracked based on a device identifier of the target device 606. In some aspects, the device identifier may correspond to the BD address of the target device, the ESL identifier of the target device, a proprietary hardware identifier, or the like, according to one or more communication standards.

At stage 614, a camping process may be performed by the management entity 603 and the target device 606, such that the target device 606 may be communicatively coupled to the ESL network as a camped ESL device. In some aspects, the target device 606 may be capable of performing periodic advertising with multiple response (PAwMR) functionality according to a BLE-based ESL standard. After the target device 606 being camped to the ESL network, the target device 606 may be configured to transmit beacons over a dedicated beaconing channel of the ESL network, a data channel in the ESL network, or multiple channels (e.g., multiple data channels or a combination of the dedicated beaconing channel and one or more data channels) in the ESL network based on a channel hopping sequence. At stage 615, the management entity 603 may report to the service entity 602 that the target device 606 has been camped to the ESL network.

At stage 616, the service entity 602 may identify one or more target devices to be tracked, including the target device 606, based on the tracking instruction. At stage 618, the service entity 602 may send, through the management entity 603, the beacon configuration to the target device 606, where the beacon configuration may specify transmission time information (e.g., indicating when the beacons will be transmitted) and transmission channel information (e.g., indicating over which channel(s) the beacons will be transmitted) regarding the transmission of the beacons by the target device 606. In some aspects, the transmission time information may correspond to the one or more beacons being transmitted periodically based on a beacon transmission time, a beacon transmission interval, or any combination thereof. In some aspects, the transmission time information may correspond to a fixed number of beacons being transmitted within a beacon transmission window. In some aspects, the transmission channel information may correspond to the one or more beacons being transmitted over a dedicated beaconing channel of the ESL network, a data channel in the ESL network, or multiple channels based on a channel hopping sequence.

After stage 618, the operations of various entities and devices may enter a targeted scanning phase 640. Compared with the processing flow 500, the process flow 600 may skip the snapshot scanning phase, as the time and channel where the beacons from the target device 606 may be found is known to the service entity 602. In some aspects, the process flow 600 may configure all ESL devices available to the service entity 602 to perform the targeted scanning operation at the targeted scanning phase 640. In some aspects, the additional (if any) power consumption as a result of using all the ESL devices during the targeted scanning phase 640 may still be justifiable by saving the power consumption as a result of skipping the snapshot scanning phase.

At stage 642 during the targeted scanning phase 640, the service entity 602 may configure the targeted scanning operation for scanning one or more beacons from the target device 606 by the set of ESL devices 605. At stage 643, the service entity 602 may configure the set of ESL devices 605 to perform the targeted scanning operation by sending, via the management entity 603 and the corresponding one or more wireless communication stations (not shown in FIG. 6), the scanning configuration from stage 642 to the set of ESL devices 605.

In some aspects according to a first scenario example, the targeted scanning operation may be based on the target device 606 periodically transmitting the one or more beacons as specified in the transmission time information. In some aspects according to a second scenario example, the targeted scanning operation may be based on the target device 606 transmitting a fixed number of beacons within a beacon transmission window as specified in the transmission time information. In some aspects according to the first scenario example and/or the second scenario example, the target device 606 may transmit the one or more beacons over the dedicated beaconing channel of the ESL network, the data channel in the ESL network, or the multiple channels in the ESL network based on the channel hopping sequence as specified in the transmission channel information.

In some aspects according to the first scenario example or the second scenario example, the service entity 602 may configure the set of ESL devices 605 to scan within a limited duration based on the transmission time information. Moreover, in some aspects, by moving the beacons to one or more data channels, collision or interference with other beacons in the dedicated beaconing channel may be reduced or avoided.

At stage 644, the set of ESL devices 605 may receive one or more beacons from the target device 606 based on the scanning configuration. In some aspects, the target device 606 may transmit the one or more beacons as specified in the beacon configuration from stage 618. In some aspects, the target device 606 may transmit beacons upon a request of the service entity 602. In some aspects, the set of ESL devices 605 may collect information for report from the beacons in a manner similar to the operations at stage 524 of the process flow 500 (in FIG. 5).

At stage 645, the service entity 602 may receive one or more targeted scanning reports from the set of ESL devices 605 based on the targeted scanning operation. In some aspects, each one of the one or more targeted scanning reports may indicate an ESL identifier associated with a reporting ESL device of the set of ESL devices 605, a device identifier associated with the target device 606, a number of one or more received bacons received by the reporting ESL device, one or more reception timestamps of the one or more received bacons received by the reporting ESL device, one or more reception signal strengths of the one or more received bacons received by the reporting ESL device, or any combination thereof. In some aspects, the device identifiers and/or the ESL identifiers may be reported in the form of indices or coded indices, where the service entity may decode the identifiers based on a lookup table. In some aspects, the one or more targeted scanning reports may be transmitted based on a large data transfer scheme in a slot according to a BLE standard.

At stage 646, the service entity 602 may engage in a positioning procedure to determine an estimated location of the target device 606 based on the one or more targeted scanning reports. In some aspects, the positioning procedure may correspond to a push-to-fix procedure based on a signature of reception signal strength of the beacons as observed by the set of ESL devices 605.

After the targeted scanning phase 640, at stage 660, the service entity 602 may report the estimated location of the target device 606 to the user terminal 601 and/or or report a tracking result based on the estimated location of the target device 606 to the user terminal 601.

In some aspects, as the transmission time information and the transmission channel information of the beacons for the targeted scanning phase 640 is known to the service entity 602 after the target device 606 is camped to the ESL network, the service entity 602 may configure the ESL devices 605 accordingly without relying on the information that may be derived from a snapshot scanning phase. In some aspects, the service entity 602 during the targeted scanning phase 640 may set the scanning frequency of the ESL devices with appropriate scanning time and/or scanning durations based on the transmission time information of the beacons, which may ensure a high probability of successfully receiving the beacons from the target device 606.

Accordingly, the ESL devices 605 may be configured to scan the beacons of the target device 606 during a limited duration based on the known time and channel information of the beacons. The target device 606 may be configured to only transmit the beacons during certain time window instead of transmitting the beacons blindly and periodically. As a result, a positioning procedure based on the processing flow 600 may be able to ascertain a location of a target device in a manner that is both timely and power-efficient (as to the ESL devices as well as the target device).

Of course, in some variations, the processing flow 600 may be modified to incorporate the snapshot scanning phase between stage 618 and the targeted scanning phase 640, in a manner similar to the snapshot scanning phase 520 illustrated in FIG. 5 at the cost of additional power consumption for executing the added snapshot scanning phase.

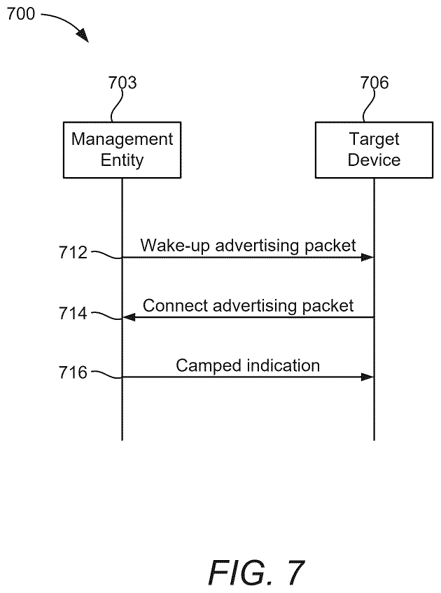

FIG. 7 illustrates an example processing flow 700 for camping a target device to an ESL network, according to aspects of the disclosure. In some aspects, the processing flow 700 indicates the operations performed by a management entity 703 (e.g., the management entity 430 in FIG. 4) configured to manage the ESL network and a target device 706 (e.g., the target device 410 in FIG. 4). In some aspects, the processing flow 700 may correspond to the operations at stage 614 in FIG. 6.

At stage 712, the management entity 703 may transmit a wake-up advertising packet, which the target device 706 may receive when the target device 706 is awaken. At stage 714, the target device 706 may transmit a connect advertising packet to the management entity 703 indicating the intention to camp to the ESL network. At stage 716, the management entity 703 may transmit a camped indication indicating that the target device 706 is now camped to the ESL network.

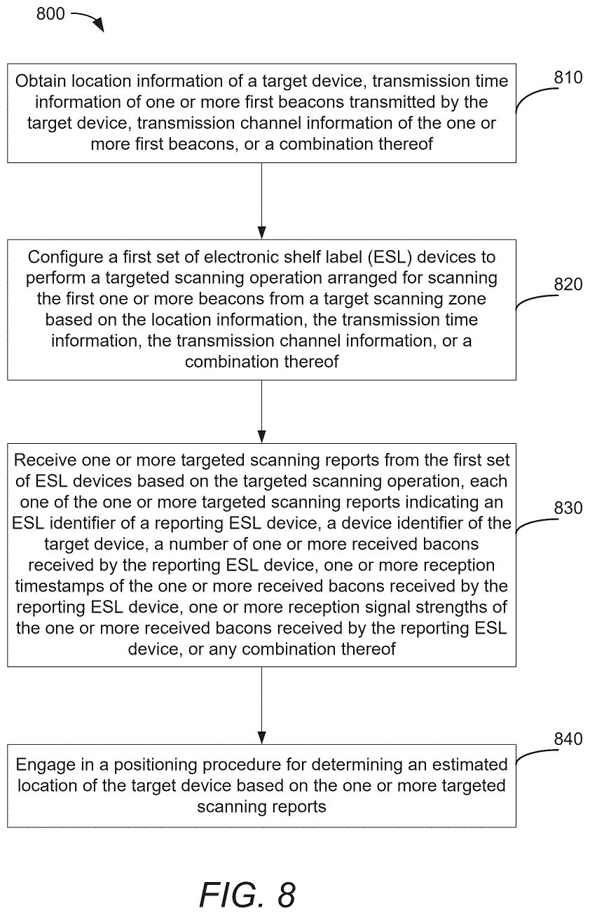

FIG. 8 is a flowchart illustrating a method 800 of operating a processing device, according to aspects of the disclosure. In some aspects, the processing device in the method 800 may correspond to the service entity described in FIGS. 1 and 4-6. In some aspects, the processing device may be a processing device 300 described in FIG. 3; and the method 800 may be performed by the one or more network transceivers 310, the one or more processors 320, the memory 330, and/or the ESL positioning component 340, any or all of which may be considered means for performing one or more of the following operations of method 800.

At operation 810, the processing device (e.g., the service entity 502 in FIG. 5 or the service entity 602 in FIG. 6) may obtain location information of a target device (e.g., the target device 506 in FIG. 5 or the target device 606 in FIG. 6), transmission time information of one or more first beacons transmitted by the target device, transmission channel information of the one or more first beacons, or a combination thereof. In some aspects, operation 810 may be performed by the one or more network transceivers 310, the one or more processors 320, the memory 330, and/or the ESL positioning component 340, any or all of which may be considered means for performing operation 810.

At operation 820, the processing device configure a first set of ESL devices (e.g., the set of ESL devices 505 in FIG. 5 or the set of ESL devices 605 in FIG. 6) to perform a targeted scanning operation arranged for scanning the first one or more beacons from a target scanning zone based on the location information, the transmission time information, the transmission channel information, or a combination thereof. In some aspects, operation 820 may be performed by the one or more network transceivers 310, the one or more processors 320, the memory 330, and/or the ESL positioning component 340, any or all of which may be considered means for performing operation 820.

In some aspects, the transmission time information and/or the transmission channel information may be obtained based on various operations of a snapshot scanning phase, as illustrated in FIG. 5. In some aspects, the method 800 may further include operations of the snapshot scanning phase, including at least configuring a second set of ESL devices (e.g., the set of ESL devices 504 in FIG. 5) to perform a snapshot scanning operation arranged for scanning second one or more beacons from a scanning space encompassing the target scanning zone; receiving one or more snapshot scanning reports from the second set of ESL devices based on the snapshot scanning operation; and determining the target scanning zone based on the one or more snapshot scanning reports. In some aspects, the scanning space may be determined based on an area of interest or a last-known location of the target device.

In some aspects, the operations of the snapshot scanning phase may further include configuring one or more other sets of ESL devices to perform the snapshot scanning operation for scanning the second one or more beacons. In some aspects, the second set of ESL devices and the one or more other sets of ESL devices may correspond to scanning different scanning zones in the scanning space.

In some aspects, the second set of ESL devices for the snapshot scanning operation may be determined based on an offline setting (e.g., preconfigured based on a floor plan of the store and locations of all the ESL devices installed in the store). In some aspects, the scanning space may be determined based on an area of interest or a last-known location of the target device, and the second set of ESL devices for the snapshot scanning operation may be determined based on the scanning space.

In some aspects, the transmission time information and/or the transmission channel information may be obtained without performing the snapshot scanning phase, as illustrated in FIG. 6. In some aspects, the first set of ESL devices may be communicatively coupled to an ESL network, and the target device may be communicatively coupled to the ESL network as a camped ESL device. In some aspects, the ESL network may be based on a BLE standard.

In some aspects, the method 800 may further include configuring the target device to transmit the first one or more beacons based on the transmission time information, the transmission time information corresponding to the first one or more beacons being transmitted periodically based on a beacon transmission time, a beacon transmission interval, or any combination thereof. In some aspects, the first set of ESL devices may be configured to scan the first one or more beacons within a scanning time window based on the transmission time information.

In some aspects, the method 800 may further include configuring the target device to transmit the first one or more beacons based on the transmission channel information, the transmission channel information corresponding to the first one or more beacons being transmitted over a dedicated beaconing channel of the ESL network, a data channel in the ESL network, or multiple channels in the ESL network based on a channel hopping sequence. In some aspects, the first set of ESL devices may be configured to scan the first one or more beacons based on the transmission channel information.

In some aspects, the method 800 may further include configuring the target device to transmit the first one or more beacons based on the transmission time information, the transmission time information corresponding to the first one or more beacons being transmitted to have a fixed number of beacons within a beacon transmission window. In some aspects, the first set of ESL devices may be configured to scan the first one or more beacons within a scanning time window based on the transmission time information.

At operation 830, the processing device may receive one or more targeted scanning reports from the first set of ESL devices based on the targeted scanning operation. In some aspects, operation 830 may be performed by the one or more network transceivers 310, the one or more processors 320, the memory 330, and/or the ESL positioning component 340, any or all of which may be considered means for performing operation 830.

In some aspects, each one of the one or more targeted scanning reports may indicate an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof.

At operation 840, the processing device may engage in a positioning procedure for determining an estimated location of the target device based on the one or more targeted scanning reports. In some aspects, operation 840 may be performed by the one or more network transceivers 310, the one or more processors 320, the memory 330, and/or the ESL positioning component 340, any or all of which may be considered means for performing operation 840.

As will be appreciated, a technical advantage of the method 800 is configuring a targeted scanning operation based on location information of a target device, transmission time information of beacons, transmission channel information of beacons, or any combination thereof, such that only a selected set of the ESL devices and/or a limited scanning time window is needed for scanning the beacons from the target device while ensuring a high probability of successfully receiving the beacons for a positioning procedure. Accordingly, the positioning procedure based on the ESL devices scanning for the beacons from the target device can be performed in a manner that is both timely and power-efficient (as to at least the ESL devices and/or the target device).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of operating a processing device, the method comprising: obtaining location information of a target device, transmission time information of first one or more beacons transmitted by the target device, transmission channel information of the first one or more beacons, or a combination thereof; configuring a first set of electronic shelf label (ESL) devices to perform a targeted scanning operation arranged for scanning the first one or more beacons from a target scanning zone based on the location information, the transmission time information, the transmission channel information, or a combination thereof; receiving one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and engaging in a positioning procedure for determining an estimated location of the target device based on the one or more targeted scanning reports.
Clause 2. The method of clause 1, further comprising: configuring a second set of ESL devices to perform a snapshot scanning operation arranged for scanning second one or more beacons from a scanning space encompassing the target scanning zone; receiving one or more snapshot scanning reports from the second set of ESL devices based on the snapshot scanning operation; and determining the target scanning zone based on the one or more snapshot scanning reports.
Clause 3. The method of clause 2, wherein: the second set of ESL devices for the snapshot scanning operation is determined based on an offline setting.
Clause 4. The method of clause 2, wherein: the scanning space is determined based on an area of interest or a last-known location of the target device, and the second set of ESL devices for the snapshot scanning operation is determined based on the scanning space.
Clause 5. The method of clause 2, further comprising: configuring one or more other sets of ESL devices to perform the snapshot scanning operation for scanning the second one or more beacons, wherein the second set of ESL devices and the one or more other sets of ESL devices correspond to scanning different scanning zones in the scanning space.
Clause 6. The method of any of clauses 2 to 5, wherein: the first set of ESL devices includes at least a portion of the second set of ESL devices that corresponds to scanning the target scanning zone.
Clause 7. The method of any of clauses 1 to 6, wherein: the first set of ESL devices is communicatively coupled to an ESL network, and the target device is communicatively coupled to the ESL network as a camped ESL device.
Clause 8. The method of clause 7, further comprising: configuring the target device to transmit the first one or more beacons based on the transmission time information, the transmission time information corresponding to the first one or more beacons being transmitted periodically based on a beacon transmission time, a beacon transmission interval, or any combination thereof, wherein the first set of ESL devices is configured to scan the first one or more beacons within a scanning time window based on the transmission time information.
Clause 9. The method of clause 7, further comprising: configuring the target device to transmit the first one or more beacons based on the transmission channel information, the transmission channel information corresponding to the first one or more beacons being transmitted over a dedicated beaconing channel of the ESL network, a data channel in the ESL network, or multiple channels in the ESL network based on a channel hopping sequence, wherein the first set of ESL devices is configured to scan the first one or more beacons based on the transmission channel information.
Clause 10. The method of clause 7, further comprising: configuring the target device to transmit the first one or more beacons based on the transmission time information, the transmission time information corresponding to the first one or more beacons being transmitted to have a fixed number of beacons within a beacon transmission window, wherein the first set of ESL devices is configured to scan the first one or more beacons within a scanning time window based on the transmission time information.
Clause 11. The method of any of clauses 7 to 10, wherein the ESL network is based on a BLUETOOTH® low energy (BLE) standard.
Clause 12. A processing device, comprising: one or more memories; one or more transceivers; and one or more processors communicatively coupled to the one or more memories and the one or more transceivers, the one or more processors, either alone or in combination, configured to: obtain location information of a target device, transmission time information of first one or more beacons transmitted by the target device, transmission channel information of the first one or more beacons, or a combination thereof; configure a first set of electronic shelf label (ESL) devices to perform a targeted scanning operation arranged for scanning the first one or more beacons from a target scanning zone based on the location information, the transmission time information, the transmission channel information, or a combination thereof; receive, via the one or more transceivers, one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and engage in a positioning procedure for determining an estimated location of the target device based on the one or more targeted scanning reports.
Clause 13. The processing device of clause 12, wherein the one or more processors, either alone or in combination, are further configured to: configure a second set of ESL devices to perform a snapshot scanning operation arranged for scanning second one or more beacons from a scanning space encompassing the target scanning zone; receive, via the one or more transceivers, one or more snapshot scanning reports from the second set of ESL devices based on the snapshot scanning operation; and determine the target scanning zone based on the one or more snapshot scanning reports.
Clause 14. The processing device of clause 13, wherein: the second set of ESL devices for the snapshot scanning operation is determined based on an offline setting.
Clause 15. The processing device of clause 13, wherein: the scanning space is determined based on an area of interest or a last-known location of the target device, and the second set of ESL devices for the snapshot scanning operation is determined based on the scanning space.
Clause 16. The processing device of clause 13, wherein the one or more processors, either alone or in combination, are further configured to: configure one or more other sets of ESL devices to perform the snapshot scanning operation for scanning the second one or more beacons, wherein the second set of ESL devices and the one or more other sets of ESL devices correspond to scanning different scanning zones in the scanning space.
Clause 17. The processing device of any of clauses 13 to 16, wherein: the first set of ESL devices includes at least a portion of the second set of ESL devices that corresponds to scanning the target scanning zone.
Clause 18. The processing device of any of clauses 12 to 17, wherein: the first set of ESL devices is communicatively coupled to an ESL network, and the target device is communicatively coupled to the ESL network as a camped ESL device.
Clause 19. The processing device of clause 18, wherein the one or more processors, either alone or in combination, are further configured to: configure the target device to transmit the first one or more beacons based on the transmission time information, the transmission time information corresponding to the first one or more beacons being transmitted periodically based on a beacon transmission time, a beacon transmission interval, or any combination thereof, wherein the first set of ESL devices is configured to scan the first one or more beacons within a scanning time window based on the transmission time information.
Clause 20. The processing device of clause 18, wherein the one or more processors, either alone or in combination, are further configured to: configure the target device to transmit the first one or more beacons based on the transmission channel information, the transmission channel information corresponding to the first one or more beacons being transmitted over a dedicated beaconing channel of the ESL network, a data channel in the ESL network, or multiple channels in the ESL network based on a channel hopping sequence, wherein the first set of ESL devices is configured to scan the first one or more beacons based on the transmission channel information.
Clause 21. The processing device of clause 18, wherein the one or more processors, either alone or in combination, are further configured to: configure the target device to transmit the first one or more beacons based on the transmission time information, the transmission time information corresponding to the first one or more beacons being transmitted to have a fixed number of beacons within a beacon transmission window, wherein the first set of ESL devices is configured to scan the first one or more beacons within a scanning time window based on the transmission time information.
Clause 22. The processing device of any of clauses 18 to 21, wherein the ESL network is based on a BLUETOOTH® low energy (BLE) standard.
Clause 23. A processing device, comprising: means for obtaining location information of a target device, transmission time information of first one or more beacons transmitted by the target device, transmission channel information of the first one or more beacons, or a combination thereof; means for configuring a first set of electronic shelf label (ESL) devices to perform a targeted scanning operation arranged for scanning the first one or more beacons from a target scanning zone based on the location information, the transmission time information, the transmission channel information, or a combination thereof; means for receiving one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and means for engaging in a positioning procedure for determining an estimated location of the target device based on the one or more targeted scanning reports.
Clause 24. The processing device of clause 23, further comprising: means for configuring a second set of ESL devices to perform a snapshot scanning operation arranged for scanning second one or more beacons from a scanning space encompassing the target scanning zone; means for receiving one or more snapshot scanning reports from the second set of ESL devices based on the snapshot scanning operation; and means for determining the target scanning zone based on the one or more snapshot scanning reports.
Clause 25. The processing device of clause 24, wherein: the second set of ESL devices for the snapshot scanning operation is determined based on an offline setting.
Clause 26. The processing device of clause 24, wherein: the scanning space is determined based on an area of interest or a last-known location of the target device, and the second set of ESL devices for the snapshot scanning operation is determined based on the scanning space.
Clause 27. The processing device of clause 24, further comprising: means for configuring one or more other sets of ESL devices to perform the snapshot scanning operation for scanning the second one or more beacons, wherein the second set of ESL devices and the one or more other sets of ESL devices correspond to scanning different scanning zones in the scanning space.
Clause 28. The processing device of any of clauses 24 to 27, wherein: the first set of ESL devices includes at least a portion of the second set of ESL devices that corresponds to scanning the target scanning zone.
Clause 29. The processing device of any of clauses 23 to 28, wherein: the first set of ESL devices is communicatively coupled to an ESL network, and the target device is communicatively coupled to the ESL network as a camped ESL device.
Clause 30. The processing device of clause 29, further comprising: means for configuring the target device to transmit the first one or more beacons based on the transmission time information, the transmission time information corresponding to the first one or more beacons being transmitted periodically based on a beacon transmission time, a beacon transmission interval, or any combination thereof, wherein the first set of ESL devices is configured to scan the first one or more beacons within a scanning time window based on the transmission time information.
Clause 31. The processing device of clause 29, further comprising: means for configuring the target device to transmit the first one or more beacons based on the transmission channel information, the transmission channel information corresponding to the first one or more beacons being transmitted over a dedicated beaconing channel of the ESL network, a data channel in the ESL network, or multiple channels in the ESL network based on a channel hopping sequence, wherein the first set of ESL devices is configured to scan the first one or more beacons based on the transmission channel information.
Clause 32. The processing device of clause 29, further comprising: means for configuring the target device to transmit the first one or more beacons based on the transmission time information, the transmission time information corresponding to the first one or more beacons being transmitted to have a fixed number of beacons within a beacon transmission window, wherein the first set of ESL devices is configured to scan the first one or more beacons within a scanning time window based on the transmission time information.
Clause 33. The processing device of any of clauses 29 to 32, wherein the ESL network is based on a BLUETOOTH® low energy (BLE) standard.
Clause 34. A non-transitory computer-readable medium storing computer-executable instructions that, when executed by a processing device, cause the processing device to: obtain location information of a target device, transmission time information of first one or more beacons transmitted by the target device, transmission channel information of the first one or more beacons, or a combination thereof; configure a first set of electronic shelf label (ESL) devices to perform a targeted scanning operation arranged for scanning the first one or more beacons from a target scanning zone based on the location information, the transmission time information, the transmission channel information, or a combination thereof; receive one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and engage in a positioning procedure for determining an estimated location of the target device based on the one or more targeted scanning reports.
Clause 35. The non-transitory computer-readable medium of clause 34, further comprising computer-executable instructions that, when executed by the processing device, cause the processing device to: configure a second set of ESL devices to perform a snapshot scanning operation arranged for scanning second one or more beacons from a scanning space encompassing the target scanning zone; receive one or more snapshot scanning reports from the second set of ESL devices based on the snapshot scanning operation; and determine the target scanning zone based on the one or more snapshot scanning reports.
Clause 36. The non-transitory computer-readable medium of clause 35, wherein: the second set of ESL devices for the snapshot scanning operation is determined based on an offline setting.
Clause 37. The non-transitory computer-readable medium of clause 35, wherein: the scanning space is determined based on an area of interest or a last-known location of the target device, and the second set of ESL devices for the snapshot scanning operation is determined based on the scanning space.
Clause 38. The non-transitory computer-readable medium of clause 35, further comprising computer-executable instructions that, when executed by the processing device, cause the processing device to: configure one or more other sets of ESL devices to perform the snapshot scanning operation for scanning the second one or more beacons, wherein the second set of ESL devices and the one or more other sets of ESL devices correspond to scanning different scanning zones in the scanning space.
Clause 39. The non-transitory computer-readable medium of any of clauses 35 to 38, wherein: the first set of ESL devices includes at least a portion of the second set of ESL devices that corresponds to scanning the target scanning zone.
Clause 40. The non-transitory computer-readable medium of any of clauses 34 to 39, wherein: the first set of ESL devices is communicatively coupled to an ESL network, and the target device is communicatively coupled to the ESL network as a camped ESL device.
Clause 41. The non-transitory computer-readable medium of clause 40, further comprising computer-executable instructions that, when executed by the processing device, cause the processing device to: configure the target device to transmit the first one or more beacons based on the transmission time information, the transmission time information corresponding to the first one or more beacons being transmitted periodically based on a beacon transmission time, a beacon transmission interval, or any combination thereof, wherein the first set of ESL devices is configured to scan the first one or more beacons within a scanning time window based on the transmission time information.
Clause 42. The non-transitory computer-readable medium of clause 40, further comprising computer-executable instructions that, when executed by the processing device, cause the processing device to: configure the target device to transmit the first one or more beacons based on the transmission channel information, the transmission channel information corresponding to the first one or more beacons being transmitted over a dedicated beaconing channel of the ESL network, a data channel in the ESL network, or multiple channels in the ESL network based on a channel hopping sequence, wherein the first set of ESL devices is configured to scan the first one or more beacons based on the transmission channel information.
Clause 43. The non-transitory computer-readable medium of clause 40, further comprising computer-executable instructions that, when executed by the processing device, cause the processing device to: configure the target device to transmit the first one or more beacons based on the transmission time information, the transmission time information corresponding to the first one or more beacons being transmitted to have a fixed number of beacons within a beacon transmission window, wherein the first set of ESL devices is configured to scan the first one or more beacons within a scanning time window based on the transmission time information.
Clause 44. The non-transitory computer-readable medium of any of clauses 40 to 43, wherein the ESL network is based on a BLUETOOTH® low energy (BLE) standard.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of operating a processing device, the method comprising:
obtaining location information of a target device, transmission time information of first one or more beacons transmitted by the target device, transmission channel information of the first one or more beacons, or a combination thereof;
configuring a first set of electronic shelf label (ESL) devices to perform a targeted scanning operation arranged for scanning the first one or more beacons from a target scanning zone based on the location information, the transmission time information, the transmission channel information, or a combination thereof;
receiving one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and
engaging in a positioning procedure for determining an estimated location of the target device based on the one or more targeted scanning reports.

2. The method of claim 1, further comprising:
configuring a second set of ESL devices to perform a snapshot scanning operation arranged for scanning second one or more beacons from a scanning space encompassing the target scanning zone;
receiving one or more snapshot scanning reports from the second set of ESL devices based on the snapshot scanning operation; and
determining the target scanning zone based on the one or more snapshot scanning reports.

3. The method of claim 2, wherein:
the second set of ESL devices for the snapshot scanning operation is determined based on an offline setting.

4. The method of claim 2, wherein:
the scanning space is determined based on an area of interest or a last-known location of the target device, and
the second set of ESL devices for the snapshot scanning operation is determined based on the scanning space.

5. The method of claim 2, further comprising:
configuring one or more other sets of ESL devices to perform the snapshot scanning operation for scanning the second one or more beacons,
wherein the second set of ESL devices and the one or more other sets of ESL devices correspond to scanning different scanning zones in the scanning space.

6. The method of claim 2, wherein:
the first set of ESL devices includes at least a portion of the second set of ESL devices that corresponds to scanning the target scanning zone.

7. The method of claim 1, wherein:
the first set of ESL devices is communicatively coupled to an ESL network, and
the target device is communicatively coupled to the ESL network as a camped ESL device.

8. The method of claim 7, further comprising:
configuring the target device to transmit the first one or more beacons based on the transmission time information, the transmission time information corresponding to the first one or more beacons being transmitted periodically based on a beacon transmission time, a beacon transmission interval, or any combination thereof,
wherein the first set of ESL devices is configured to scan the first one or more beacons within a scanning time window based on the transmission time information.

9. The method of claim 7, further comprising:
configuring the target device to transmit the first one or more beacons based on the transmission channel information, the transmission channel information corresponding to the first one or more beacons being transmitted over a dedicated beaconing channel of the ESL network, a data channel in the ESL network, or multiple channels in the ESL network based on a channel hopping sequence,
wherein the first set of ESL devices is configured to scan the first one or more beacons based on the transmission channel information.

10. The method of claim 7, further comprising:
configuring the target device to transmit the first one or more beacons based on the transmission time information, the transmission time information corresponding to the first one or more beacons being transmitted to have a fixed number of beacons within a beacon transmission window,
wherein the first set of ESL devices is configured to scan the first one or more beacons within a scanning time window based on the transmission time information.

11. The method of claim 7, wherein the ESL network is based on a BLUETOOTH® low energy (BLE) standard.

12. A processing device, comprising:
one or more memories;
one or more transceivers; and
one or more processors communicatively coupled to the one or more memories and the one or more transceivers, the one or more processors, either alone or in combination, configured to:
obtain location information of a target device, transmission time information of first one or more beacons transmitted by the target device, transmission channel information of the first one or more beacons, or a combination thereof;
configure a first set of electronic shelf label (ESL) devices to perform a targeted scanning operation arranged for scanning the first one or more beacons from a target scanning zone based on the location information, the transmission time information, the transmission channel information, or a combination thereof;
receive, via the one or more transceivers, one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and
engage in a positioning procedure for determining an estimated location of the target device based on the one or more targeted scanning reports.

13. The processing device of claim 12, wherein the one or more processors, either alone or in combination, are further configured to:
configure a second set of ESL devices to perform a snapshot scanning operation arranged for scanning second one or more beacons from a scanning space encompassing the target scanning zone;
receive, via the one or more transceivers, one or more snapshot scanning reports from the second set of ESL devices based on the snapshot scanning operation; and
determine the target scanning zone based on the one or more snapshot scanning reports.

14. The processing device of claim 13, wherein:
the second set of ESL devices for the snapshot scanning operation is determined based on an offline setting.

15. The processing device of claim 13, wherein:
the scanning space is determined based on an area of interest or a last-known location of the target device, and
the second set of ESL devices for the snapshot scanning operation is determined based on the scanning space.

16. The processing device of claim 13, wherein the one or more processors, either alone or in combination, are further configured to:
configure one or more other sets of ESL devices to perform the snapshot scanning operation for scanning the second one or more beacons,
wherein the second set of ESL devices and the one or more other sets of ESL devices correspond to scanning different scanning zones in the scanning space.

17. The processing device of claim 13, wherein:
the first set of ESL devices includes at least a portion of the second set of ESL devices that corresponds to scanning the target scanning zone.

18. The processing device of claim 12, wherein:
the first set of ESL devices is communicatively coupled to an ESL network, and
the target device is communicatively coupled to the ESL network as a camped ESL device.

19. The processing device of claim 18, wherein the ESL network is based on a BLUETOOTH® low energy (BLE) standard.

20. A non-transitory computer-readable medium storing computer-executable instructions that, when executed by a processing device, cause the processing device to:
obtain location information of a target device, transmission time information of first one or more beacons transmitted by the target device, transmission channel information of the first one or more beacons, or a combination thereof;
configure a first set of electronic shelf label (ESL) devices to perform a targeted scanning operation arranged for scanning the first one or more beacons from a target scanning zone based on the location information, the transmission time information, the transmission channel information, or a combination thereof;
receive one or more targeted scanning reports from the first set of ESL devices based on the targeted scanning operation, each one of the one or more targeted scanning reports indicating an ESL identifier of a reporting ESL device, a device identifier of the target device, a number of one or more received bacons received by the reporting ESL device, one or more reception timestamps of the one or more received bacons received by the reporting ESL device, one or more reception signal strengths of the one or more received bacons received by the reporting ESL device, or any combination thereof; and
engage in a positioning procedure for determining an estimated location of the target device based on the one or more targeted scanning reports.
